(19) United States
(12) Patent Application Publication
(10) Pub. No.: US 2015/0296285 A1
(43) Pub. Date: Oct. 15, 2015

(54) Audio System

(71) Applicant: Bluewire Audio LLC, Northborough, MA (US)

(72) Inventors: Andrew Proos, Northborough, MA (US); Emily Proos, Northborough, MA (US); Anthony Perrone, Braintree, MA (US); Christopher Carbone, Attleboro, MA (US)

(21) Appl. No.: 14/686,840

(22) Filed: Apr. 15, 2015

Related U.S. Application Data
(60) Provisional application No. 61/979,691, filed on Apr. 15, 2014.

(51) Int. Cl. H04R 1/10; H04R 1/02

(52) U.S. Cl. CPC H04R 1/105; H04R 1/025

(57) ABSTRACT

An audio system that is constructed and arranged to be carried by a headwear that is adapted to be worn on a person's head. The audio system includes one or two sound delivery assemblies, each sound delivery assembly comprising a housing, and a loudspeaker that generates sound in the housing, where the housing has a sound-emitting opening that emits sound generated by the loudspeaker. There is a wiring harness that is constructed and arranged to transmit audio signals from an audio device to the loudspeakers. There are one or two coupling devices. Each coupling device is constructed and arranged to releasably couple a sound delivery assembly to the headwear such that the sound emitting opening of the sound delivery assembly is located proximate an ear when the headwear is on the person's head.

### CROSS-REFERENCE TO RELATED APPLICATION

This application claims benefit from U.S. Provisional Patent Application Ser. No. 61/979,691, filed on Apr. 15, 2014, the contents of which are incorporated herein by reference.

### BACKGROUND

This disclosure relates to an audio system that is carried by headwear such as hats, visors, headbands and helmets.

Portable media devices are used to provide audio content while engaged in physical activities such as walking, running or yard work. These devices produce an electronic signal that is converted to audible sound by transmission to various audio reproduction devices including headphones, earphones and ear buds. It is known in the art that headphones are near-ear versions of loudspeakers worn in contact with the external ear, and in one embodiment are worn in a position covering the ear canal. Earphones or ear buds are in-ear versions of loudspeakers and are worn in contact with the ear canal.

Issues of convenience arise from both styles of audio reproduction devices when they are worn by a user engaged in physical activities. They share the problem of the tangled wires that connect them to the portable media device. Earphones and ear buds are also prone to becoming dislodged during physical activity. Headphones are generally more securely held in place than ear-buds, but may also become mal-positioned.

Headphones, earphones and ear buds are designed to minimize ambient noise. Indeed, the latest technologies include active noise cancelling functionality combined with a physical design that optimizes sound reproduction and may effectively eliminate ambient background noise. While this is a highly desirable feature for some user circumstances, it may create a safety concern when these devices are utilized during physical activities, particularly in an outdoor setting. One by-product of eliminating ambient noise is an impact on the wearer's ability to hear environmental sounds that signal a safety issue.

### SUMMARY

All examples and features mentioned below can be combined in any technically possible way.

In one aspect, an audio system is constructed and arranged to be carried by headwear that is adapted to be worn on a person's head. The audio system includes one or two sound delivery assemblies. Each sound delivery assembly includes a housing and a loudspeaker that generates sound in the housing, where the housing has a sound-emitting opening that emits sound generated by the loudspeaker. There is a wiring harness that is constructed and arranged to transmit audio signals from an audio device to the loudspeakers. The wiring harness may be hidden in the headwear, e.g., behind the sweatband of a baseball cap-style hat. There are one or two coupling devices. Each coupling device is constructed and arranged to releasably couple a sound delivery assembly to the headwear such that the sound emitting opening of the sound delivery assembly is located proximate an ear when the headwear is on the person's head.

Embodiments may include one of the following features, or any combination thereof. The housing may define an interior volume, and the loudspeaker may be located in the interior volume of the housing. The sound emitting opening of the sound delivery assembly may be located above an ear when the headwear is on the person's head. The housing may have an inner portion located proximate the head and an outer portion that is opposed to the inner portion. The loudspeaker may generate sound generally along a sound generation axis, and the sound generation axis may be directed toward one portion of the housing. The sound generation axis may be directed toward the inner portion of the housing. The coupling device may couple the sound delivery assembly to the headwear proximate and just above an ear of the wearer. There may be two sound delivery assemblies and two coupling devices, and the wiring harness may have two ends, with a plug at one end and wiring that leads from the plug to one loudspeaker and then to the second loudspeaker, where the wiring ends at the second loudspeaker.

Embodiments may include one of the following features, or any combination thereof. The coupling device may comprise a backing plate that releasably connects to the housing. The releasable connection may be magnetic based. Both the housing and the backing plate may comprise magnets, the magnets arranged to come into contact when the backing plate and housing are connected. The backing plate and the housing may interfit. The backing plate and the housing may be keyed such that they interfit in only one orientation. One of the backing plate and housing may comprise a projection and the other may have a receiving structure that receives the projection when the backing plate and housing are interfitted. The housing may comprise a flange that defines the receiving structure. The flange may fit through an opening in the headwear with the headwear sitting against the housing outside of the flange. The backing plate may comprise the projection that sits inside of the flange. The housing may comprise a pair of electrical contacts that make electrical contact with the loudspeaker, and the backing plate may comprise two electrical contacts that are electrically coupled to the wiring harness. The electrical contacts of the backing plate may touch the electrical contacts of the housing when the backing plate and housing are interfitted.

In another aspect, an audio system that is constructed and arranged to be carried by headwear that is adapted to be worn on a person's head, includes at least one sound delivery assembly, each sound delivery assembly comprising a housing and a loudspeaker that generates sound in the housing, where the housing has a sound-emitting opening that emits sound generated by the loudspeaker, wherein the housing defines an interior volume and the loudspeaker is located in the interior volume of the housing and wherein the sound emitting opening of the sound delivery assembly is located above an ear when the headwear is on the person's head. There is a wiring harness that is constructed and arranged to transmit audio signals from an audio device to the loudspeaker. There is at least one coupling device, each coupling device constructed and arranged to releasably couple a sound delivery assembly to the headwear such that the sound emitting opening of the sound delivery assembly is located proximate an ear when the headwear is on the person's head, wherein the coupling device comprises a backing plate that releasably connects to the housing and couples the sound delivery assembly to the headwear proximate an ear of the wearer.

Embodiments may include one of the above and/or below features, or any combination thereof. Both the housing and the backing plate may comprise magnets, the magnets arranged to come into contact when the backing plate and housing are connected. The backing plate and the housing may be keyed such that they interfit in only one orientation. One of the backing plate and the housing may comprise a projection and the other may have a receiving structure that receives the projection when the backing plate and housing are interfitted. The housing may comprise a pair of electrical contacts that make electrical contact with the loudspeaker, and the backing plate may comprise two electrical contacts that are electrically coupled to the wiring harness; the electrical contacts of the backing plate touch the electrical contacts of the housing when the backing plate and housing are interfitted. There may be two sound delivery assemblies and two coupling devices, wherein the wiring harness has two ends, with a plug at one end and wiring that leads from the plug to one loudspeaker and then to the second loudspeaker, where the wiring ends at the second loudspeaker.

In another aspect, an audio apparatus or system includes a body and a housing. The housing encloses or carries aspects of the body, which includes a set of speakers and an electrical communication apparatus. More specifically, the housing may include a first primary aperture to receive a first speaker, and a second primary aperture to receive a second speaker. In doing so, the housing positions the first speaker relative to the second speaker. This positioning may be linear when the body is in a first position.

In another aspect, this disclosure includes a kit that has a body and a housing, wherein the housing encloses aspects of the body. The body includes a set of speakers, including a first speaker and a second speaker. The speakers are linearly aligned and are in electrical communication. Headwear (such as a hat) may be part of the kit, or may be provided separately. Such headwear may be constructed and arranged to hold an audio apparatus or system such that audio signals from an audio device are routed to loudspeakers located near but not on or in the ears. The housing, which encloses the body, includes a set of apertures, including a first aperture and a second aperture. The first aperture receives the first speaker and the second aperture receives the second speaker. The housing functions to secure the body to the headwear, and in one embodiment, to mount the body within a hat with the speakers located near the ears of the wearer.

### BRIEF DESCRIPTION OF THE DRAWINGS

FIG. 1 is perspective view of a hat carrying a first example of an audio system according to the invention.

FIG. 2 shows the wiring harness.

FIGS. 3A-3J detail the sound delivery assembly.

FIGS. 4A and 4B are exploded views of a sound delivery assembly being coupled to a hat.

FIGS. 4C and 4D are plan views of the coupling device and sound delivery assembly.

FIGS. 5A and 5B show the housing and coupling device engaged with the wiring harness.

FIG. 6A shows a hat with an engaged audio system, and FIGS. 6B and 6C are cross-sectional views taken along line A-A of FIG. 6A.

FIG. 7 is a side sectional view of a speaker system comprising a second example of the subject invention.

FIG. 8 is a bottom view of the first and second speakers of the speaker system shown in FIG. 7 in communication with the housing.

FIG. 9 is side view of a housing shown in FIG. 7 attached to a secondary surface.

FIG. 10A is a highly schematic sectional view of a securing mechanism employed for the attachment to the secondary surface.

FIG. 10B is a partial, exploded cross-sectional view of a securing mechanism and a speaker, and FIG. 10C is a bottom view of the speaker engaged in the hat.

FIG. 11 is an interior sectional view of the housing shown in FIG. 7 circumscribing an interior segment of a head covering.

FIG. 12 is a sectional view of a kit employing the speaker system of FIG. 7.

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

### DETAILED DESCRIPTION

It will be readily understood that the components of the present invention, as generally described and illustrated in the figures herein, may be arranged and designed in a wide variety of different configurations. Thus, the following more detailed description of the embodiments of the system, apparatus and kit of the present invention, as presented in the figures, is not intended to limit the scope of the invention, as claimed, but is merely representative of selected embodiments of the invention.

Reference throughout this specification to “a select embodiment,” “one embodiment,” or “an embodiment” or “example” means that a particular feature, structure, or characteristic described in connection with the embodiment is included in at least one embodiment o f the present invention. Thus, appearances of the phrases “a select embodiment,” “in one embodiment,” or “in an embodiment” in various places throughout this specification are not necessarily all referring to the same embodiment or example.

Furthermore, the described features, structures, or characteristics may be combined in any suitable manner in one or more embodiments. In the following description, numerous specific details are provided, such as examples of speaker system elements and head covering associated therewith to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

Music is commonly stored on digital music players and smartphones, with these devices having an adapter (such as a jack) to receive headphones, earphones, or ear buds. Different configurations are known in the art for providing an audio signal with the configurations based on design and style of the headphones, ear phones, or ear buds. All have the same limitations when utilized during physical activity such as exercise, running or any mobile activity, especially in the outdoor setting.

One of the challenges with the prior art configurations is keeping the headphones, earphones, or ear buds in close proximity to the ears. Each of these devices has tendency for falling out of the ear or changing positions. There are also safety concerns when these traditional devices are worn in an outdoor setting as they are all designed to minimize or eliminate ambient sounds. The described speaker system is a wearable system positioned in a secure fashion and external to the ear in a manner that mitigates both of these concerns. Accordingly, the sound delivery system described in detail below employs speakers for the sound delivery and at the same time positions the speakers in a manner that does not require periodic readjustment and preserves ambient background sounds.

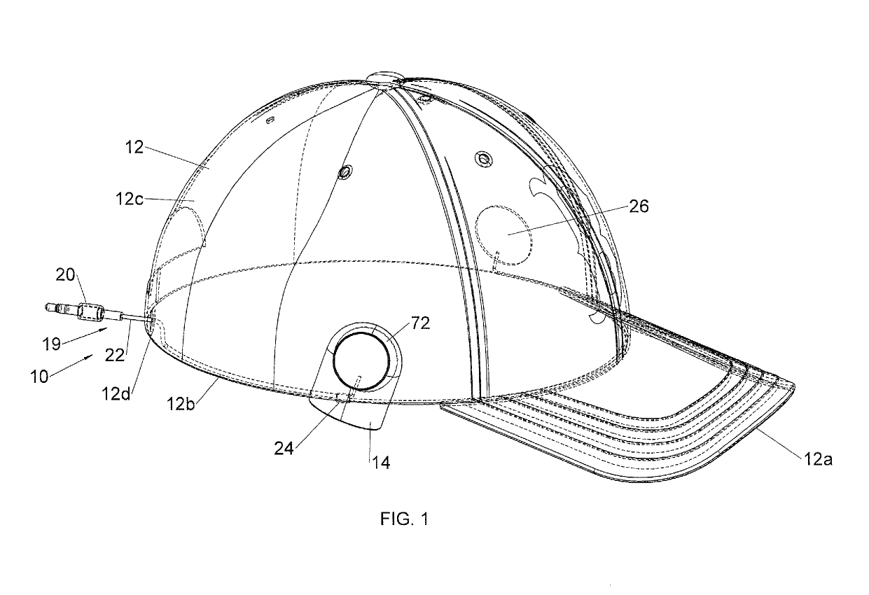

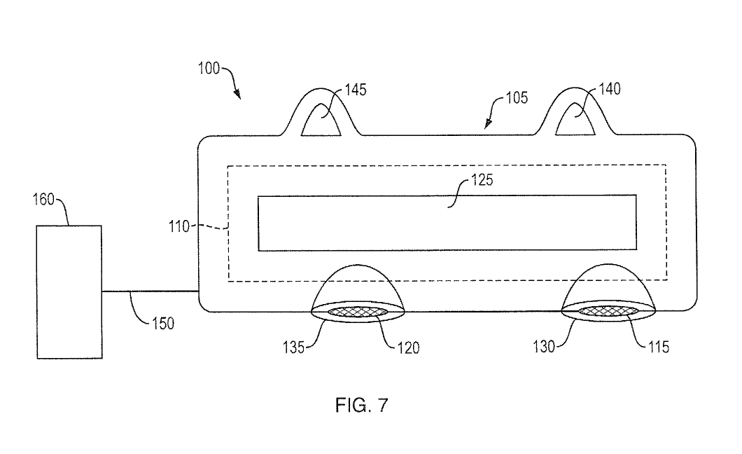

A first embodiment of the present invention is shown in FIGS. 1-6. A second embodiment is shown in FIGS. 7-12.

Audio system 10 is shown in FIGS. 1-6. Audio system 10 is constructed and arranged to be carried by hat 12. In this non-limiting example hat 12 is a baseball cap with a crown 12c having a lower edge 12b; crown 12c sits on the head. Hat 12 also has a bill or peak 12a. Audio system 10 could be carried by any other type of headwear, such as a visor, a headband or a helmet to name several additional but non-limiting examples. The manner in which system 10 is carried by the hat as disclosed herein is not limiting of the myriad ways that an audio system could be carried in headwear with the loudspeakers situated such that there outputs are just above, at, or just below the tops of the ears.

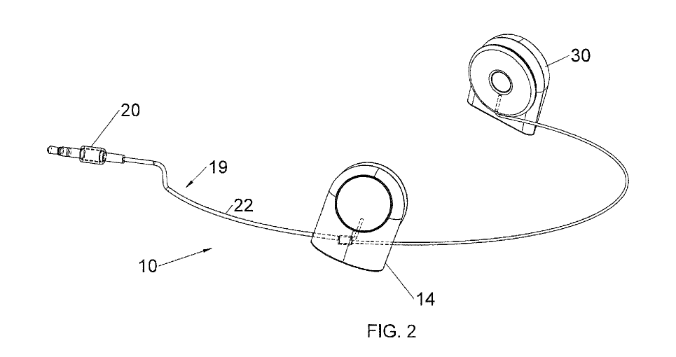

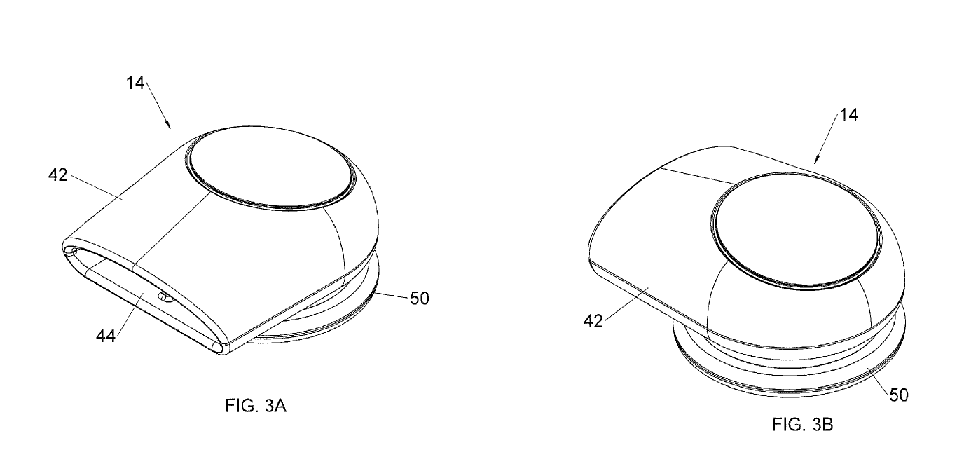

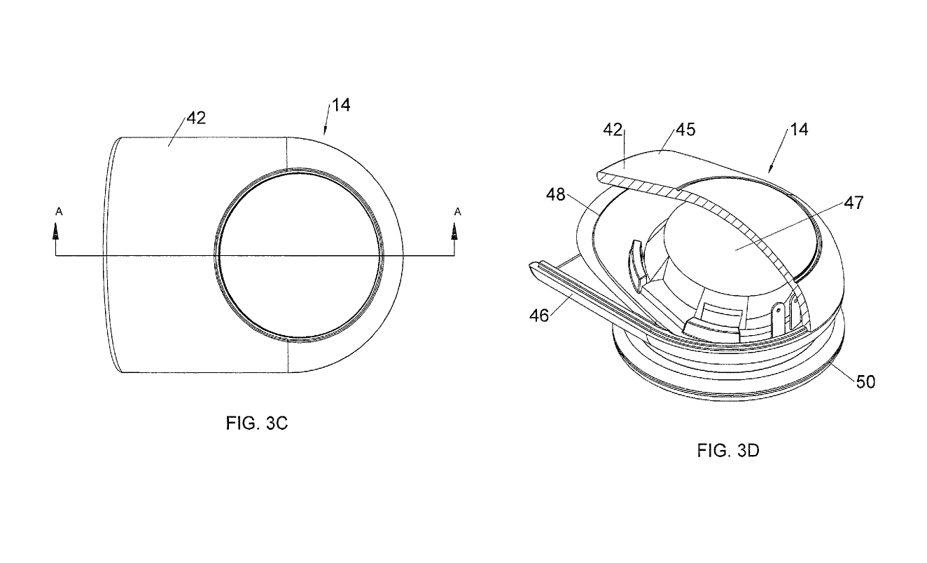

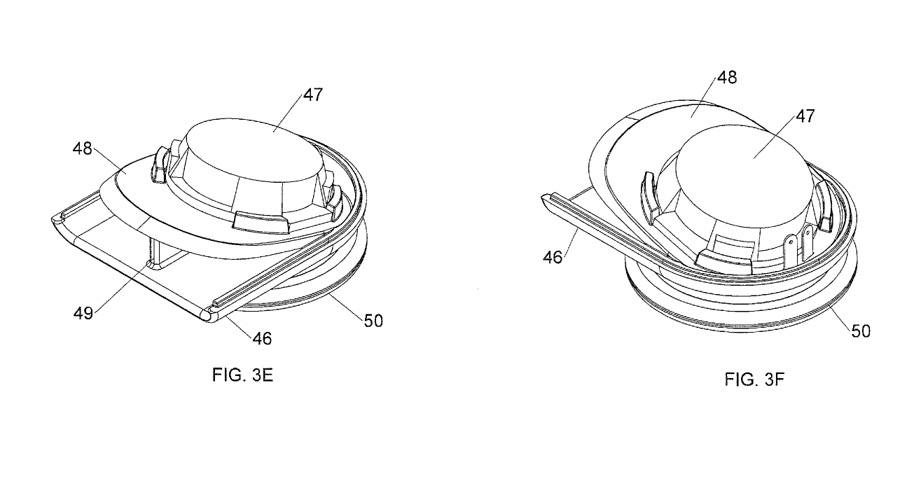

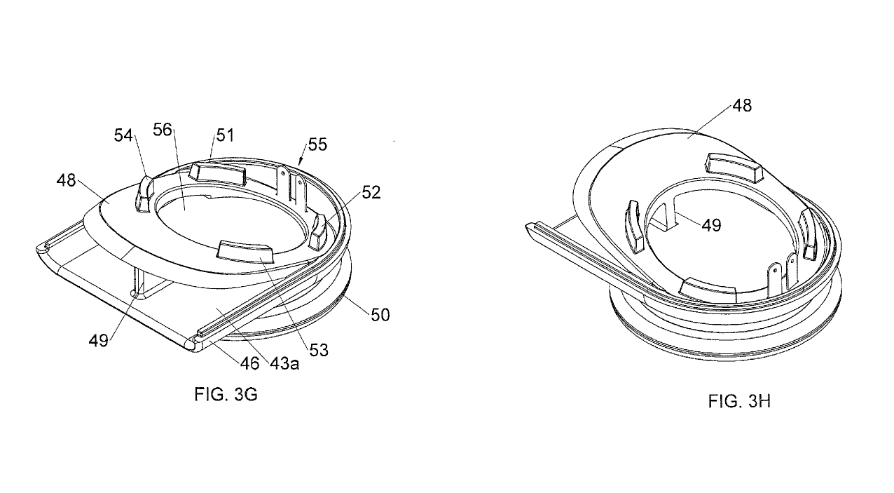

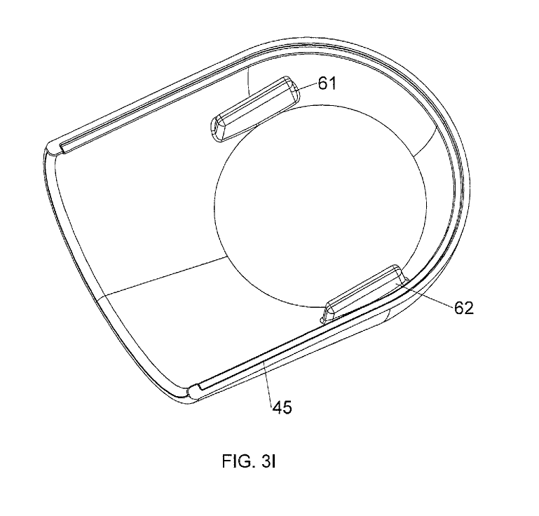

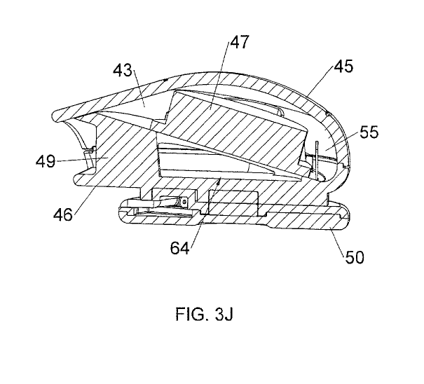

Audio system 10 has at least one sound delivery assembly. Sound delivery assembly 14 is shown in FIG. 1 and second sound delivery assembly 30 is shown in FIG. 2. These two sound delivery assemblies may be identical, with one arranged to provide sound near the right ear of the wearer of the hat and one designed to provide sound near the left ear. Sound delivery assembly 14 is shown in detail in FIGS. 3A-3J, and includes housing 42 that houses loudspeaker 47 that generates sound in housing 42. Housing 42 has a sound-emitting opening 44 that emits sound generated by loudspeaker 47. Audio system 10 further includes wiring harness 19 that is constructed and arranged to transmit audio signals from an audio device to a loudspeaker in the sound delivery assemblies. Wiring harness 19 in this example includes plug 20 at one end. Plug 20 may be located outside of the hat as shown. Plug 20 may be adapted to be received in an output jack of a device that outputs audio signals such as a digital music player (e.g., an iPod Nano®) or the like. For example, audio system 10 can be used with a small digital audio player that has a mounting clip that can be carried by the adjustment band on the back of the hat. Wire 22 passes through buttonhole 12d that is created in the back portion of the hat and runs along the inside of the hat near its bottom edge 12b and so carries audio signals to the loudspeakers in sound delivery assemblies 14 and 30. In one non-limiting arrangement illustrated in FIG. 1, wire 22 runs forward to assembly 14 and then continues along under bill 12a to assembly 30, where it ends. FIG. 2 shows assembly 30. Wire 22 may be hidden between the hat/sweat band and the body/crown of the hat.

Audio system 10 also includes a coupling device 50. See FIG. 3 for details. There is one such coupling device for each sound delivery assembly. The coupling device is constructed and arranged to releasably attach to the housing and thus couple a sound delivery assembly to the hat such that the sound emitting opening of the housing is located proximate an ear (typically but not necessarily just above the ear) when the hat is on a person's head with the bill over the face of the wearer. In this non-limiting example coupling device 50 sits against the inside of crown 12c over an opening such as opening 26, FIG. 1, made in the crown and located above the expected location of an ear of the person wearing the hat. Sound emitting opening 44 in this example is designed to sit just above the ear so that sound generated by the loudspeaker leaves the housing close to the ear canal. This arrangement provides a high quality sound to each ear of the wearer while also allowing the wearer to hear ambient sounds since the ear is not covered and the ear canal is not blocked.

One sound delivery assembly 14 is shown in detail in FIGS. 3A-3J. Housing 42 comprises outer housing portion 45 and inner housing portion 46. The interior volume 43 of housing 42 is between these housing portions. Loudspeaker 47 in this case is located in this interior volume. In another example (not shown) the loudspeaker could be located partially outside the volume 43 but emit sound into the interior volume of the housing so that the sound would exit through sound emitting opening 44.

The design and arrangement detailed in FIG. 3 is but one example of myriad ways in which the sound delivery assembly could be designed. In this case, loudspeaker 47 emits sound generally along sound generation axis 64 shown in FIG. 3J, into sound conducting space 43a between housing portion 46 and partition 48. Sound conducting space 43a could include devices or substances meant to improve sound quality, such as baffles or sound absorbing material. Sound generation axis 64 is in this case directed at housing portion 46. Most of the sound will reflect off the inside of the housing before leaving the opening. An alternative arrangement could have the loudspeaker mounted with axis 64 pointed in a different direction, such as towards another portion of the housing or pointed directly toward housing opening 44.

There are many possible ways to mount loudspeaker 47 at an angle to the interior of the housing as shown in the drawings. In this one non-limiting example, loudspeaker 47 is carried by angled partition 48 that is supported relative to housing portion 46 by wall 49. Bosses 51-54 are arranged to tightly hold and constrain the loudspeaker around its circumference, so it does not move. Upper housing portion 45 has projection 61 and 62 which sit against or close to the top of the loudspeaker to hold it tightly in place. There is a pair 55 of electrical contacts that make electrical contact with the loudspeaker. This aspect is further described below.

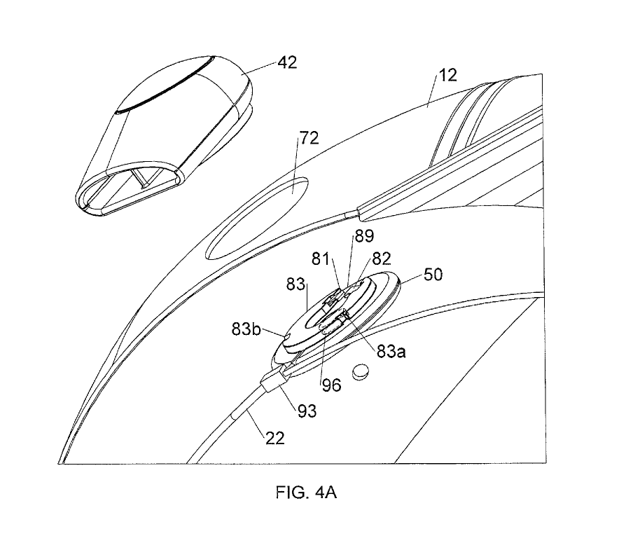

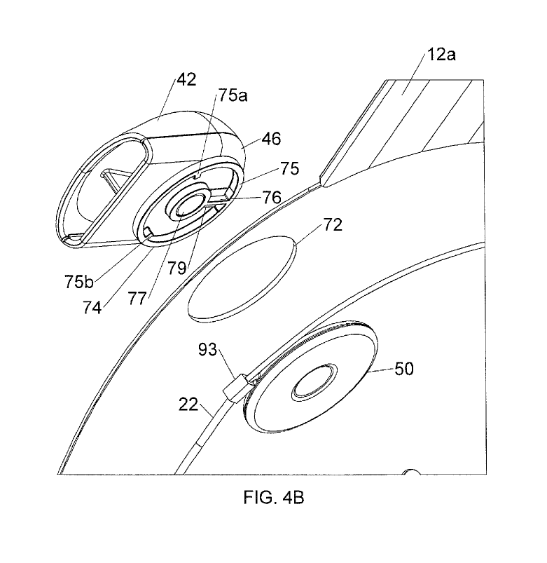

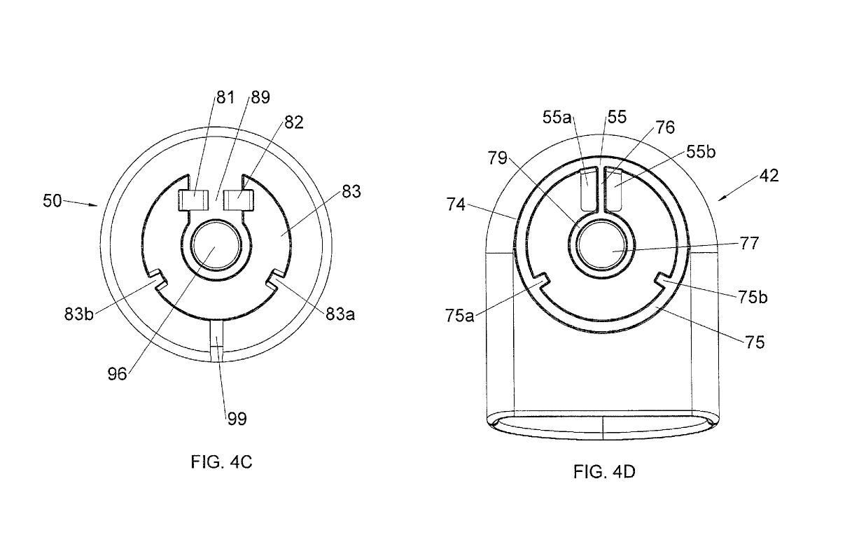

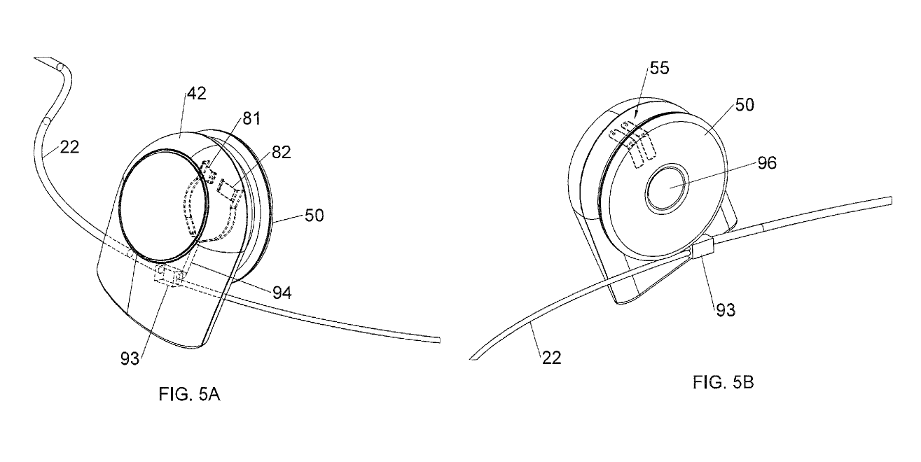

Housing 42 is shown in the process of being coupled to opening 72 in hat 12, in FIGS. 4A and 4B. FIGS. 4C and 4D are plan views of the coupling device and housing of FIGS. 4A and 411 Coupling device 50 in this case is a generally flat circular plate with interior projection (raised portion) 83 that is sized and shaped to be received in receiving structure 74 of housing 42. Coupling device 50 may be located between the headband and crown of the hat so it is hidden from view, and also so that the coupling device does not touch or rub against the head. Receiving structure 74 comprises keyed flange 75 (with keys 75a and 75b) that has an inner raised portion 79 and a raised connecting portion 76. Portion 83 is sized and shaped to sit in the volume between flange 75 and raised portion 79, with its slot 89 fitted over connecting portion 76 and its peripheral slots 83a and 83b fitted over keys 75a and 75b. This arrangement accomplishes a keyed interfitting of the coupling device and the housing in which the two can properly interfit in only one rotational orientation. Magnet 96 is carried by coupling device 50 and magnet 77 is carried by housing 42. When the two parts are interfitted the magnets hold them together. This arrangement ensures that the pair of electrical contacts 81, 82 carried by coupling device or back plate 50 properly engage with contacts 55a and 55b of the pair of contacts 55 that are electrically coupled to the loudspeaker. The contacts can be made of spring steel and arranged such that they are tightly held together when engaged. Wiring harness wire 22 delivers audio signals to contacts 81 and 82 via wire junction or splitter 93, and lead 94 that fits into slot 99. See also, FIG. 5A. This way, when coupling device 50 is properly coupled to housing 42 the audio signals are passed through to the loudspeaker.

Note that there are other manners of releasably coupling together a housing and a coupling device, and the above is simply one manner of releasable coupling that is considered to fall within the scope of the present disclosure. Also, the speaker could be carried by the coupling device rather than the housing, and the speaker output could be located in the housing when the coupling device was coupled to the housing. In this case, the housing would simply redirect the speaker output toward the ears. Such an arrangement would not require any electrical connection between the coupling device and the housing.

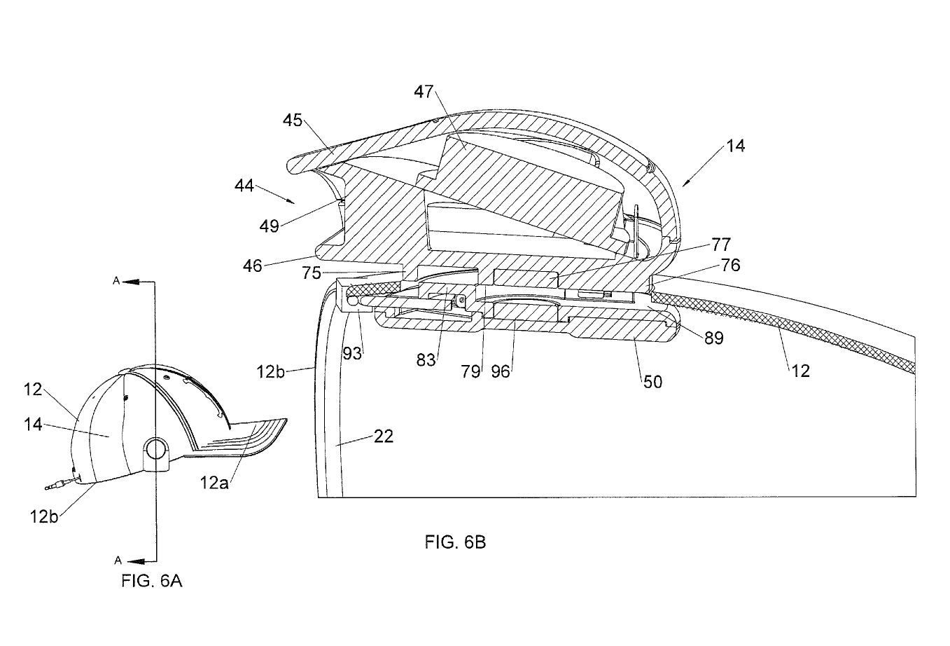

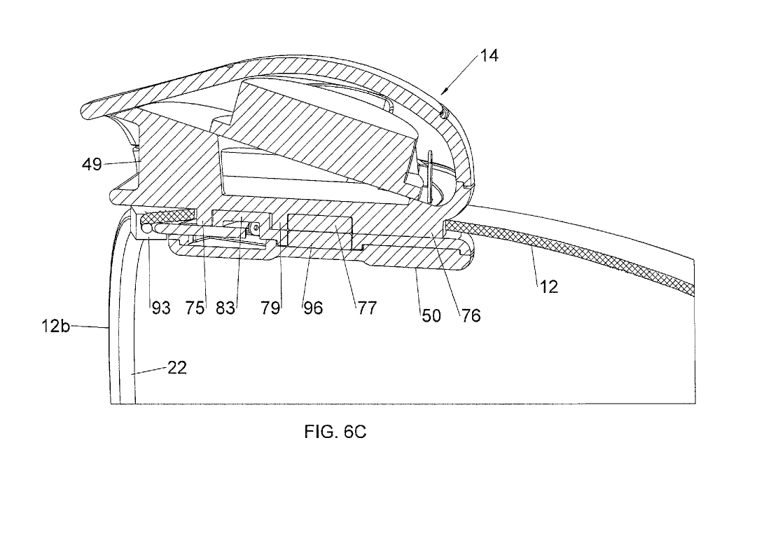

FIGS. 6B and 6C detail how the housing and coupling device are fitted together and are coupled to hat 12 such that housing opening 44 is located just above the right ear of the wearer. FIG. 6B shows the housing and coupling device about to engage, and FIG. 6C shows them engaged. See FIG. 6A for a side view.

Another example of an audio system/speaker system apparatus 100 is shown in FIGS. 7-12. This apparatus may include a body and a housing. The housing encloses aspects of the body, which includes a set of speakers and an electrical communication apparatus. More specifically, the housing includes a first primary aperture to receive a first speaker, and a second primary aperture to receive a second speaker. In doing so, the housing may align the first speaker relative to the second speaker in a linear arrangement when the body is in a first position. In one example, apparatus 100 is designed to be hidden between the crown and headband of a hat.

In another aspect, a kit is provided. The kit includes a body and a housing, wherein the housing encloses aspects of the body. The body includes a set of speakers, including a first speaker and a second speaker. The speakers may be linearly aligned, and are in electrical communication. A head covering (headwear) can be part of the kit. The housing, which encloses the body, includes a set of apertures, including a first aperture and a second aperture. The first aperture receives the first speaker and the second aperture receives the second speaker. The housing functions to secure the body to the head covering, and in one embodiment, to mount the body within the head covering.

FIG. 7 is a highly schematic sectional view of one embodiment of a speaker system apparatus 100, hereinafter sometimes referred to as “the apparatus.” The apparatus includes a housing 105 that encloses aspects of the body 110. At least two speakers, 115 and 120, respectively, and an electrical communication apparatus 125 are provided. In one embodiment, additional speakers may be incorporated into the apparatus. Similarly, in one embodiment, the apparatus may be limited to a single speaker. The housing 105 has a first primary aperture 130 to receive the first speaker 115 and a second primary aperture 135 to receive the second speaker 120. The first and second speakers, 115 and 120, respectively, are linearly aligned in a first position. The speakers are in electrical communication. The electrical communication apparatus may comprise one or more wires (not shown) and provide the electrical communication of the speakers 115 and 120. Accordingly, the housing 105 encloses aspects of the body 110, including enclosing the electrical communication apparatus 125 comprising the wire(s) (not shown) and at least partially enclosing the speakers, 115 and 120.

The configuration of the housing 105 maintains an alignment of the first speaker 115 relative to the second speaker 120, which in one embodiment is an electrical and mechanical alignment. In one embodiment, the electrical communication apparatus 125 comprises wire(s) (not shown) connecting the first speaker 115 to the second speaker 120. For example, the electrical communication apparatus 125 may connect the first speaker 115 to the second speaker 120. In one embodiment, the speakers are connected in a parallel circuit. The configuration of the electrical communication apparatus 125 is not considered limiting and may be adjusted to augment electrical communication between the first speaker 115 and the second speaker 120. For example, in one embodiment, the first and second speakers, 115 and 120, respectively, may be wireless speakers, with the housing 105 functioning to hold the speakers in relative proximity. To that end, the electrical communication apparatus 125 comprises the speakers 115 and 120 as wireless speakers. In addition, the size of the speakers, 115 and 120, is not considered limiting and may be increased or decreased to augment sound. Accordingly, the housing 105 holds the first and second speakers 115 and 120, respectively.

The apparatus 100 further comprises a set of secondary apertures in communication with the housing 105, including a first secondary aperture 140 adjacent to the first primary aperture 130 and a second secondary aperture 145 adjacent to the second primary aperture 135. As shown, the first secondary aperture 140 is aligned with the first primary aperture 130 and the second primary aperture 145 is aligned with the second secondary aperture 135. In one embodiment, the alignment described herein is a vertical alignment of the identified secondary aperture with the respective primary aperture. Each of the secondary apertures 140 and 145 are employed to secure the housing 105 to a secondary surface (e.g., the headwear).

The apparatus 100 further comprises a distal wire 150 in a relative horizontal alignment to the first and second speakers, 115 and 120, and external to the housing 105. The distal wire 150 is employed as an electrical connection between the speakers 115 and 120 and a secondary device 160. Secondary device 160 may be part of apparatus 100 or may be a separate device such as a digital music player. Wire 150 may be in electrical communication with electrical communication apparatus 125. Within the housing 105, the speakers 115 and 120 are electrically connected, which in one embodiment is a parallel circuit configuration. In one embodiment, the secondary device is a receiver 160 in communication with the distal wire 150. The secondary device 160 may be in wired or wireless communication with a music player. One example of a receiver protocol is a Bluetooth receiver, although other receivers may be employed with the apparatus, such as a music player. The secondary device 160 may be adapted to secure to a head covering, or to an alternative apparatus in close proximity to the housing 105 and associated speakers, 115 and 120. The secondary device 160 may be secured to a head covering. Further, the secondary device 160 may include a computing device. Additionally, the secondary device 160 may include an extension wire. The configuration of the secondary device 160, such as receivers, is not considered limiting. Accordingly, various secondary devices 160 may be provided in communication with the housing 105 and associated speakers, 115 and 120, for delivery of audible communication.

As shown in FIG. 7, the housing 105 holds the speakers, 115 and 120, in position, and specifically in a linear alignment. The housing 105 is comprised of malleable materials and enables the housing 105 to change its shape, while continuing to hold the components in position. For example, in one embodiment, the housing 105 may take the form of a second shape, such as a semi-circle to conform to the shape of a head covering. The first and second speakers, 115 and 120, continue to be held in position relative to the housing 105. In addition, the functionality of the housing 105 remains constant with a change in form.

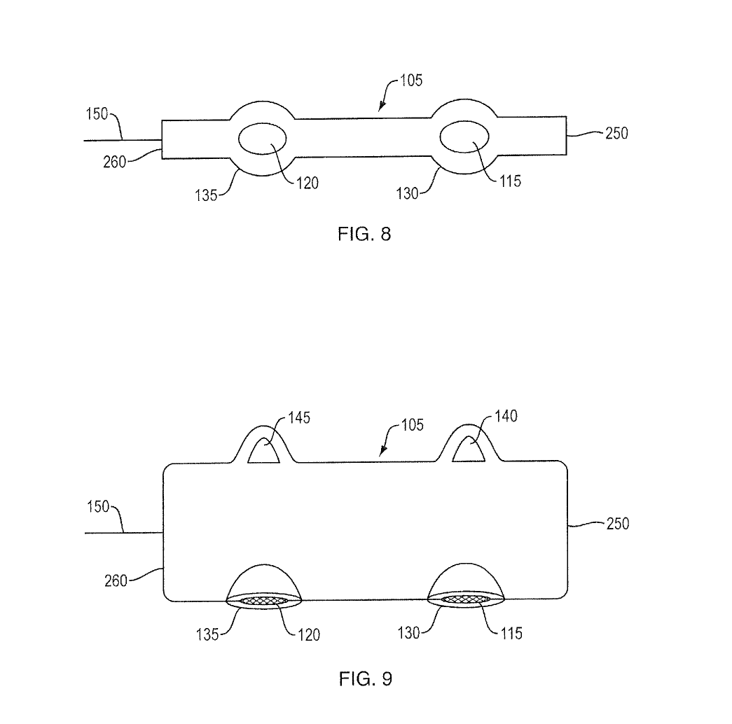

Referring to FIG. 8, a bottom view of the first and second speakers in communication with the housing is provided. The distal wire 150, the first speaker 115, and the second speaker 120 are shown in a relatively linear alignment. As shown, the housing 105 has a relatively linear arrangement, with the housing including a proximal end 250 and a distal end 260. The first speaker 115 is adjacent to the proximal end 250 and distal from the distal wire 150. The second speaker 120 is adjacent to the distal end 260 and in close proximity to the distal wire 150. As shown, the distal wire 150 is external to the housing 105. In one embodiment, the distal wire 150 may be internal to the housing 105. The distal wire 150 is in electrical communication with the electrical communication apparatus (not shown), which is in electrical communication with both the first and second speakers, 115 and 120, respectively. In one embodiment, the distal wire 150 includes a connector to carry an audio (or video) signal for communication with a secondary device. The first primary aperture 130 receives the first speaker 115, and the second primary aperture 135 receives the second speaker 120. Accordingly, the housing 105 functions to at least partially enclose the first speaker 115 and second speaker 120, and to hold them in relative alignment. Similarly, the housing 105 functions to align the speakers, 115 and 120, with the distal wire 150, thereby creating a sound system.

As shown in FIGS. 7 and 8, the first speaker, the second speaker, and the distal wire are positioned and housed in relative alignment to each other. The distance between the first speaker and the second speaker is not considered limiting and may be increased or decreased to augment electrical communication and/or delivery of sound to the speakers. Similarly, in one embodiment, the distance between the first speaker and second speaker may be limited or changed by a size of an associated head covering.

Referring to FIG. 9, a side view of one embodiment of the housing for attachment to a secondary surface is provided. The housing 105 comprises two primary apertures, 130 and 135, and two secondary apertures 140 and 145. The apertures 130 and 135, respectively, are configured to receive the first speaker 115 and the second speaker 120, respectively. The first primary aperture 130 is oppositely disposed to the distal wire 150 and proximate to the proximal end 250 of the housing 105. The second primary aperture 135 is proximate to both the distal wire 150 and the distal end 260 of the housing 105. Each of the first and second secondary apertures 140 and 145 are configured to receive a securing mechanism, as described below. The first primary aperture 130 is aligned with the first secondary aperture 140 in the housing 105, and the second primary aperture 135 is aligned with the second secondary aperture 145 in the housing 105.

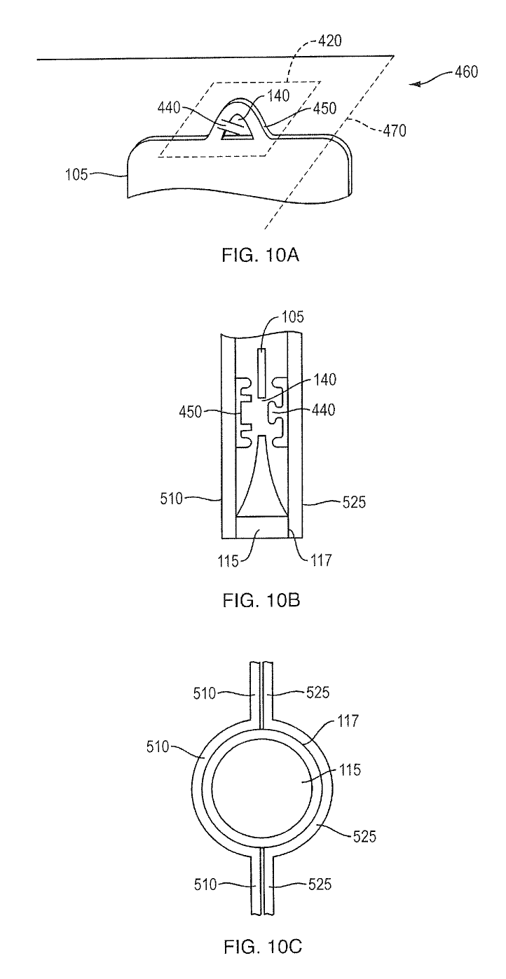

Referring to FIG. 10A, a front view of a securing mechanism employed for the attachment to the secondary surface is provided. The housing 105 that holds the speakers is in communication with the distal wire for an ambient sound delivery system. With that in mind, an exemplary embodiment of a securing mechanism 420 for the first secondary aperture 140 is described herein. A securing mechanism for the second secondary aperture (not shown) may be similarly executed. As shown herein, the securing mechanism 420 for the first secondary aperture 140 may comprise two primary components: an attachment element 440 and a securing element 450. Alternatively, the securing mechanism 420 may be comprised of a singular component, referred to herein as attachment element 440.

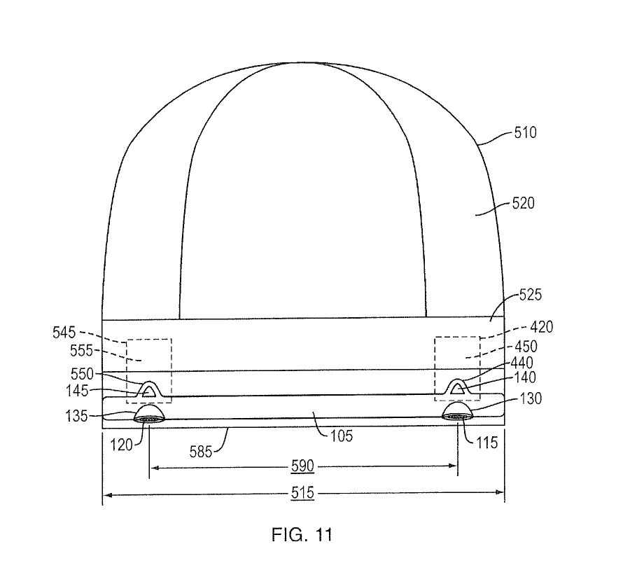

A secondary surface 460 holds the housing 105 in position so that the audio transmitted from the speakers is received in close proximity to the ears. In one embodiment, the attachment element 440 and the securing element 450 are secured to the secondary surface 460. Further, both the attachment element 440 and the securing element 450 may be embedded within the secondary surface 460. The secondary surface 460 may be a head covering with a band 470. Alternatively, the secondary surface 460 may be a band 470, which partially or completely circumscribes the head. An exemplary embodiment of a head covering is presented in FIG. 11 and described below. At the same time, by use of the securing mechanism 420, the housing 105 may be detached from the secondary surface 460. The detachment of the housing 105 from the secondary surface 460 allows the secondary surface 460 to be cleaned without affecting the integrity of the electronics enclosed in the housing 105.

Further describing the securing mechanism 420, the attachment element 440 secures the first secondary aperture 140 of the housing 105. In one embodiment, the attachment element 440 is a snap fastener stud. In the embodiment shown, both the attachment element 440 and a securing element 450 are attached to the same secondary surface 460, although this is not a limitation. For example, one may be attached to a band of a hat and the other may be attached to the crown of the hat. The securing element 450 in the secondary surface 460 connects to the attachment element 440 through the first secondary aperture 140. In doing so, the securing mechanism 420 secures the housing 105 to the secondary surface 460 through the first secondary aperture 140. As shown, the securing element 450 may be a snap fastener socket. With this in mind, the securing mechanism 420 may comprise “snapping” an attachment element 440 to a securing element 450 through the first secondary aperture 140.

FIGS. 10B and 10C illustrate another non-limiting manner in which housing 105 may be carried by head covering (e.g., hat) 510. In this case, hat 510 has inner sweatband 525 inside, along the bottom edge of the crown of the hat. Band 525 is typically sewn to the material comprising the head covering along a bottom seam. In this example, the bottom seam is opened up at two locations (apertures) just above where the ears are expected to be. A speaker (e.g., speaker 115) is fitted into the resulting aperture 117 in the bottom seam of the hat. Housing 105 may be a flexible sheet-like element such as sewn cloth or tape that engages with the speakers and the wiring harness. A small aperture (e.g., a reinforced hole) 140 can be formed in housing 105. Attachment element 440 (in this case comprising a snap fastener stud) can fit through aperture 140. Stud 440 is received in snap fastener socket 450. This removably holds housing 105 in a location where speaker 115 is fitted into aperture 117. Housing 105 can sit between the hat sweatband and the inside of the hat material.

Referring to FIG. 11, an interior sectional view of the housing secured to a secondary surface including a band and a head covering is provided. The housing 105 may be secured to the head covering 510 along a segment 515 of the head covering 510. The segment 515 may be interior to the head covering 510. Further, the segment 515 as shown circumscribes a section less than an entire interior circumference of the head covering 510. Additionally, the segment 515 as shown herein is located proximate to the front 520 of the head covering 510.

As discussed above, a band 525 attached to the head covering 510 can be involved in attaching the housing 105 to the head covering 510. As shown, a first securing mechanism 420 is provided with two ends, including a first attachment element 440 and a first securing element 450. Similarly, a second securing mechanism 545 is provided with two ends, including a second attachment element 550 and a second securing element 555. In the embodiment shown herein, the first and second attachment elements, 440 and 550, respectively, are fixed to the head covering 510 and the first and second securing elements, 450 and 555, are fixed to the band 525. The housing 105 is placed between the head covering 510 and the band 525.

The first and second attachment elements, 440 and 550, respectively, are received by and extend through the first and second secondary apertures, 140 and 145, respectively, to secure the housing 105 to both the head covering 510 and the band 525. Specifically, the band 525 communicates with the interior of the head covering 510, enabling contact between the first securing element 450 and the first attachment element 440 and between the second securing element 555 and the second attachment element 550. In one embodiment, the band 525 is located adjacent to the perimeter of the head covering 510 and folds in a first direction, e.g. upward, to enclose the housing 105. Similarly, in one embodiment, the band 525 is in close proximity to the perimeter of the head cover 510 and folds in a second direction, e.g., downward, to enclose the housing 105. In each of these embodiments, and as shown in FIG. 11, an opening is formed between the head covering 510 and the band, with the opening configured to receive the housing 105. In one embodiment, the housing 105 may be concealed relative to the head covering 510. As shown, the band 525 is located in an interior section of the head covering 510. When the housing 105 is secured to the head covering 510 and the band 525, the band 525 conceals the housing 105. Accordingly, the configuration of the band 525 with respect to the head covering 510 enables the housing 105 to be received by and secured to the head covering 510, while also remaining concealed from observance.

The first primary aperture 130 and the second primary aperture 135 of the housing 105 may be in flush communication with the bottom 585, which in one embodiment functions as an axis, of the head covering 510. This enables the speakers 115 and 120 to appear as part of the covering without providing an obstruction to the use of the head covering 510.

The first and second speakers, 115 and 120, are spaced apart a fixed distance 596, as defined by the configuration of the housing 105. The positioning of the speakers, 115 and 120, augments delivering the digital signal. For instance, the first and second speakers, 115 and 120, respectively, may be positioned relatively perpendicular to the electrical communication apparatus in the body or to the housing 105.

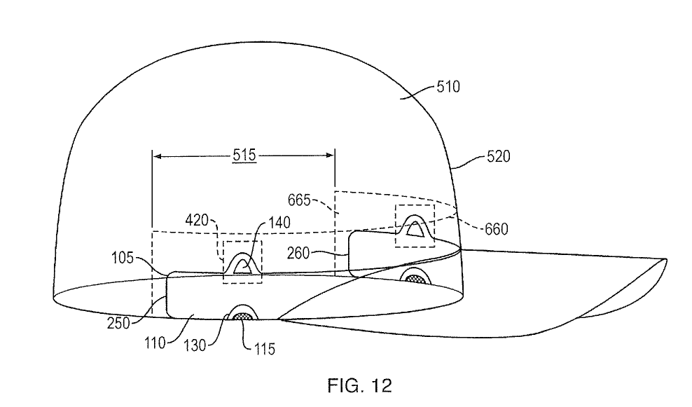

A kit utilizing concepts of the invention is illustrated in FIG. 12. More specifically, FIG. 12 is a sectional view of one embodiment of the kit, including a body 110, a housing 105 enclosing aspects of the body 110, and a head covering 510, with the housing 105 providing a means to secure the body 110 to the head covering 510. The body 110 comprises a first speaker 115 received by a first primary aperture 130 and a second speaker 120 received by a second primary aperture 135. The first and second speakers, 115 and 120, respectively, are in aligmnent and electrical communication.

As shown and described in FIG. 7, the housing included with this kit includes an electrical apparatus having one or more wires and provides the electrical communication of the speakers, 115 and 120. In an alternate embodiment, the speakers may be in wireless communication. The speakers, 115 and 120, provide audio through the first and second primary apertures, 130 and 135, respectively, in the housing 105.

The first and second speakers, 115 and 120, respectively, may be in linear alignment prior to securing the housing 105 enclosing the body 110 to a head covering 510, but the alignment may change once the housing 105 is secured to the head covering 510 or once the wearer wears the claimed apparatus. The housing 105 holds the speakers 115 and 120 in position, and specifically, in linear alignment. The housing 105 includes a proximal end 250 and distal end 260. The first speaker 115 is adjacent to the proximal end 250 and the second speaker 120 is adjacent to the distal end 260. The first and second speakers, 115 and 120, respectively, are spaced apart a fixed distance, as designed by the configuration of the housing 105. The positioning of the speakers, 115 and 120, augments delivering the signal, which in one embodiment may be an audio or digital signal. For instance, the first and second speakers, 115 and 120, respectively, may be positioned relatively perpendicular to the electrical communication apparatus in the body 110 or to the housing 105. The positioning of the speakers provides an ambient sound delivery system that enables the speakers to be placed in close proximity to the ear(s). In one embodiment, the ambient sound delivery system enables reception of ambient external sounds, such as background noise.

The housing 105 is comprised of malleable materials and enables the housing 105 to change its shape, while continuing to hold the components in position. For example, in one embodiment, the housing 105 may take the form of a second shape, such as a semi-circle to conform to the shape of the head covering 510. The first and second speakers, 115 and 120, respectively, continue to be held in position relative to the housing 105. In addition, the functionality of the housing 105 remains constant, with the change in form. Accordingly, the housing 105 encloses aspects of the body 110 including the electrical communication apparatus, comprising wire(s), and at least partially encloses the speakers 115 and 120. Alternatively, housing 105 can hold the speakers in place in other manners.

The kit may further comprise a first securing mechanism 420 and a second securing mechanism (not shown). As discussed above, each securing mechanism comprises an attachment element and a securing element. The attachment elements and the securing elements are used to secure the housing 105 to the head covering 510. In one embodiment, only attachment elements are used to secure the housing 105 to the head covering 510. For instance, a first secondary aperture 140 in the housing 105 may be positioned to be received by a first attachment element (not shown) as part of the securing mechanism 420. Similarly, although not shown, a second secondary aperture in the housing 105 may be positioned to be received by a second attachment element as part of a second securing mechanism. Accordingly, the use of the first securing mechanism 420 and second securing mechanism (not shown), provides for detachment of the housing 105 from the head covering 510 to be cleaned without affecting the integrity of the electronics enclosed in the housing 105.

The kit may further comprise a concealer 660, that is, a means of concealing, to receive, secure, and enclose the housing 105 enclosing aspects of the body 110. The concealer 660 may absorb moisture circumscribing the interior (665) of the head covering 510 during activity and keep the moisture away from the body 110, including the electrical communication apparatus. An exemplary concealer 660 may be a pocket. Alternatively, the concealer may be a band such as band 525, FIG. 11. The body 110 may be enclosed in a housing 105 and concealed in the concealer 660 of the head covering 510. The concealer 660 may circumscribe a segment 515 of the interior 665 of the head covering 510. Further, the segment 515 may circumscribe a section less than the entire interior 665 circumference of the head covering 510. Additionally, the segment 515 may be located proximate to the front 520 of the head covering 510. When the housing 105 is secured to the head covering 510 the concealer 660 conceals the housing 105. Accordingly, the configuration of the concealer 660 with respect to the head covering 510 enables the housing 105 to be received by and secured to the head covering 510, while also remaining concealed from observance.

The various examples of the audio system/apparatus/kit can be sold together with headwear that is arranged to carry the audio system/apparatus, or can be sold separately. When as described herein the audio system is enabled to be releasably coupled to headwear such as a hat, one such system can be used with multiple hats, moved by the user from one hat to another. Thus, hats and other headwear that is constructed and arranged to carry an audio system can be sold separately from the audio system. Also, the removability allows the audio system to be removed from the headwear so the headwear can be washed. The headwear per se forms aspects of the present invention.

The present invention may be embodied in other specific forms without departing from its spirit or essential characteristics. The described embodiments are to be considered in all respects only as illustrative and not restrictive. Some aspects of the invention are shown in some drawings and not others for the sake of convenience only. Also, aspects of the example shown in FIGS. 1-6 can be used in the examples shown in FIGS. 7-12, and vice versa.

The scope of the invention is, therefore, indicated by the appended claims rather than by the foregoing description. All changes which come within the meaning and range of equivalency of the claims are to be embraced within their scope. Accordingly, the scope of protection of this invention is limited only by the claims and their equivalents.

A number of implementations have been described. Nevertheless, it will be understood that additional modifications may be made without departing from the scope of the inventive concepts described herein, and, accordingly, other embodiments are within the scope of the following claims.

What is claimed is:

1. An audio system that is constructed and arranged to be carried by headwear that is adapted to be worn on a person's head, the audio system comprising:
at least one sound delivery assembly, each sound delivery assembly comprising a housing and a loudspeaker that generates sound in the housing, where the housing has a sound-emitting opening that emits sound generated by the loudspeaker;
a wiring harness that is constructed and arranged to transmit audio signals from an audio device to the loudspeaker; and
at least one coupling device, each coupling device constructed and arranged to releasably couple a sound delivery assembly to the headwear such that the sound emitting opening of the sound delivery assembly is located proximate an ear when the headwear is on the person's head.

2. The audio system of claim 1 wherein the housing defines an interior volume and the loudspeaker is located in the interior volume of the housing.

3. The audio system of claim 1 wherein the sound emitting opening of the sound delivery assembly is located above an ear when the headwear is on the person's head.

4. The audio system of claim 1 wherein the housing has an inner portion located proximate the head and an outer portion that is opposed to the inner portion.

5. The audio system of claim 4 wherein the loudspeaker generates sound generally along a sound generation axis, and the sound generation axis is directed toward one portion of the housing.

6. The audio system of claim 5 wherein the sound generation axis is directed toward the inner portion of the housing.

7. The audio system of claim 1 wherein the coupling device couples the sound delivery assembly to the headwear proximate an ear of the wearer.

8. The audio system of claim 1 wherein the coupling device comprises a backing plate that releasably connects to the housing.

9. The audio system of claim 8 wherein the releasable connection is magnetic based.

10. The audio system of claim 9 wherein both the housing and the backing plate comprise magnets, the magnets arranged to come into contact when the backing plate and housing are connected.

11. The audio system of claim 8 wherein the backing plate and housing interfit.

12. The audio system of claim 11 wherein the backing plate and housing are keyed such that they interfit in only one orientation.

13. The audio system of claim 11 wherein one of the backing plate and housing comprises a projection and the other has a receiving structure that receives the projection when the backing plate and housing are interfitted.

14. The audio system of claim 13 wherein the housing comprises a flange that defines the receiving structure and the flange fits through on opening in the headwear with the headwear sitting against the housing outside of the flange, and wherein the backing plate comprises the projection that sits inside of the flange.

15. The audio system of claim 11 wherein the housing comprises a pair of electrical contacts that make electrical contact with the loudspeaker and wherein the backing plate comprises two electrical contacts that are electrically coupled to the wiring harness, and wherein the electrical contacts of the backing plate touch the electrical contacts of the housing when the backing plate and housing are interfitted.

16. The audio system of claim 1 comprising two sound delivery assemblies and two coupling devices, wherein the wiring harness has two ends, with a plug at one end and wiring that leads from the plug to one loudspeaker and then to the second loudspeaker, where the wiring ends at the second loudspeaker.

17. An audio system that is constructed and arranged to be carried by headwear that is adapted to be worn on a person's head, the audio system comprising:
at least one sound delivery assembly, each sound delivery assembly comprising a housing and a loudspeaker that generates sound in the housing, where the housing has a sound-emitting opening that emits sound generated by the loudspeaker, wherein the housing defines an interior volume and the loudspeaker is located in the interior volume of the housing and wherein the sound emitting opening of the sound delivery assembly is located above an ear when the headwear is on the person's head;
a wiring harness that is constructed and arranged to transmit audio signals from an audio device to the loudspeaker; and
at least one coupling device, each coupling device constructed and arranged to releasably couple a sound delivery assembly to the headwear such that the sound emitting opening of the sound delivery assembly is located proximate an ear when the headwear is on the person's head, wherein the coupling device comprises a backing plate that releasably connects to the housing and couples the sound delivery assembly to the headwear proximate an ear of the wearer.

18. The audio system of claim 17 wherein both the housing and the backing plate comprise magnets, the magnets arranged to come into contact when the backing plate and housing are connected.

19. The audio system of claim 18 wherein the backing plate and housing are keyed such that they interfit in only one orientation, and wherein one of the backing plate and housing comprises a projection and the other has a receiving structure that receives the projection when the backing plate and housing are interfitted.

20. The audio system of claim 19 wherein the housing comprises two electrical contacts that make electrical contact with the loudspeaker and wherein the backing plate comprises two electrical contacts that are electrically coupled to the wiring harness, and wherein the electrical contacts of the backing plate touch the electrical contacts of the housing when the backing plate and housing are interfitted.

21. The audio system of claim 17 comprising two sound delivery assemblies and two coupling devices, wherein the wiring harness has two ends, with a plug at one end and wiring that leads from the plug to one loudspeaker and then to the second loudspeaker, where the wiring ends at the second loudspeaker.

22. The audio system of claim 21 wherein the headwear comprises a hat with a crown that is adapted to sit on the head, and a headband on the inside of the crown along its bottom edge, wherein the plug of the wiring harness is located outside of the crown and the wiring is located at least in part between the crown and the headband, wherein the audio system is constructed and arranged to be removable from the hat.
